(19) United States
(12) Patent Application Publication
(10) Pub. No.: US 2010/0030588 A1
(43) Pub. Date: Feb. 4, 2010

(54) NATIONWIDE AUTO REPAIRS AND TRAFFIC VIOLATION INSURANCE

(76) Inventor: Lillie Bolongia, (US)

Correspondence Address: DeLeon Law Group PC, 100 Crescent Court, Suite 700, Dallas, TX, 75201, US

(21) Appl. No.: 12/575,865

(22) Filed: Oct. 8, 2009

Related U.S. Application Data
(63) Continuation of application No. 11/586,011, filed on Feb. 3, 2007.

(51) Int. Cl. G06Q 40/00; G06F 17/30

(52) U.S. Cl. 705/4; 707/10; 707/E17.044

(57) ABSTRACT

A method for providing insurance for repairs and resolving traffic violations covers approved repairs for the vehicle and handles requirements to resolve traffic violations for covered operators of the vehicle at little or no added expense to the owner or operator of the vehicle.

### CROSS-REFERENCE TO RELATED APPLICATIONS

This application is a Continuation in Part of U.S. patent application Ser. No. 11,586,011, filed Feb. 3, 2007, the entire content of which is incorporated herein by reference.

### FIELD OF THE INVENTION

The present disclosure relates to a method for providing insurance coverage for unexpected vehicle repairs and traffic citations.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is a sample application for vehicle repairs coverage according to one embodiment of the present invention;

FIG. 2A is a first page of a sample application for traffic violation coverage for persons operating a commercial truck according to one embodiment of the present invention;

FIG. 2B is a second page of the sample application for traffic violation coverage for persons operating a commercial truck shown in FIG. 2A;

FIG. 3A is a first page of a sample application for traffic violation coverage for persons operating non-commercial automobiles according to one embodiment of the present invention;

FIG. 3B is a second page of the ample application for traffic violation coverage for persons operating non-commercial automobiles shown in FIG. 3A

FIG. 4 is a sample insurance coverage card for persons having insurance according to one embodiment of the present invention;

FIG. 5 is a request form to obtain records from a driver's respective state's department of motor vehicles according to one embodiment of the present invention;

FIG. 6 is a notice regarding the Federal Driver's Policy Protection Act provided to persons requesting insurance coverage according to the present invention;

FIG. 7A is a first sample vehicle inspection form which is completed during evaluation for insurance coverage according to one embodiment of the present invention;

FIG. 7B is a second sample vehicle inspection form which is completed during evaluation for insurance coverage according to one embodiment of the present invention; and

FIG. 8 is a sample claim form for drivers submitting claims for repairs and traffic violations according to one embodiment of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

There are many expected, recurring expenses associated with operating of motor vehicles, including, but not limited to registration, inspection, and other fees required by each state in which the vehicle is registered and operates; routine maintenance; liability insurance; and many more. It is often difficult for some persons to obtain monies in order to pay for these expected recurring costs; however, it is sometime cost and time prohibitive for persons to pay for unexpected costs that may occur such as major mechanical repairs and traffic violations.

Major mechanical repairs such as engine repair, transmission repair, unexpected tire replacement, and the like can costs hundreds if not thousands of dollars. Further, an owner or operator may spend hours getting multiple estimates from different vendors on the extent and costs of what repairs are needed.

Likewise, traffic violations are very cost and time consuming in that a recipient must personally appear in the jurisdiction where the violation was received, either in person or by mail. Further, the recipient must pay fines and court costs associated with the violation.

Presently, owners and operator of vehicle are able to purchase liability and collision insurance to pay expenses in the event of an accident, but these insurance policies do not provide protection or reimbursement in the event of unexpected repairs or traffic violations. Thus, a need exists for an insurance system which provides coverage and alleviates the costs associated with vehicle repairs and traffic violations whereby an owner or operator is not burdened with financial or time obligations to either repair the vehicle or pay for traffic violations.

The present invention comprises an automobile repair and traffic violation insurance system which overcomes the foregoing and other difficulties which have long since characterized the prior art. In accordance with the broader aspects of the invention an owner and/or operator of a vehicle obtains repair and traffic violation insurance for one or more vehicles, the insurance thereby paying for approved repairs for the vehicle and handling requirements to resolve traffic violations for covered operators of the vehicle at little or no added expense to the owner or operator of the vehicle.

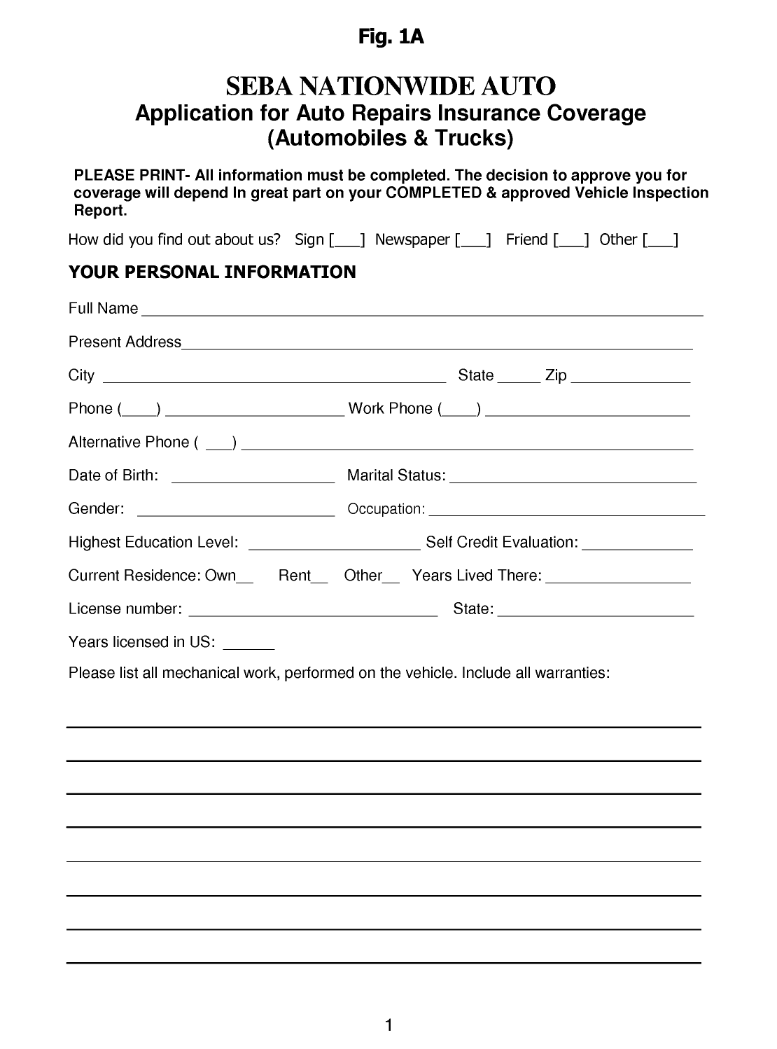

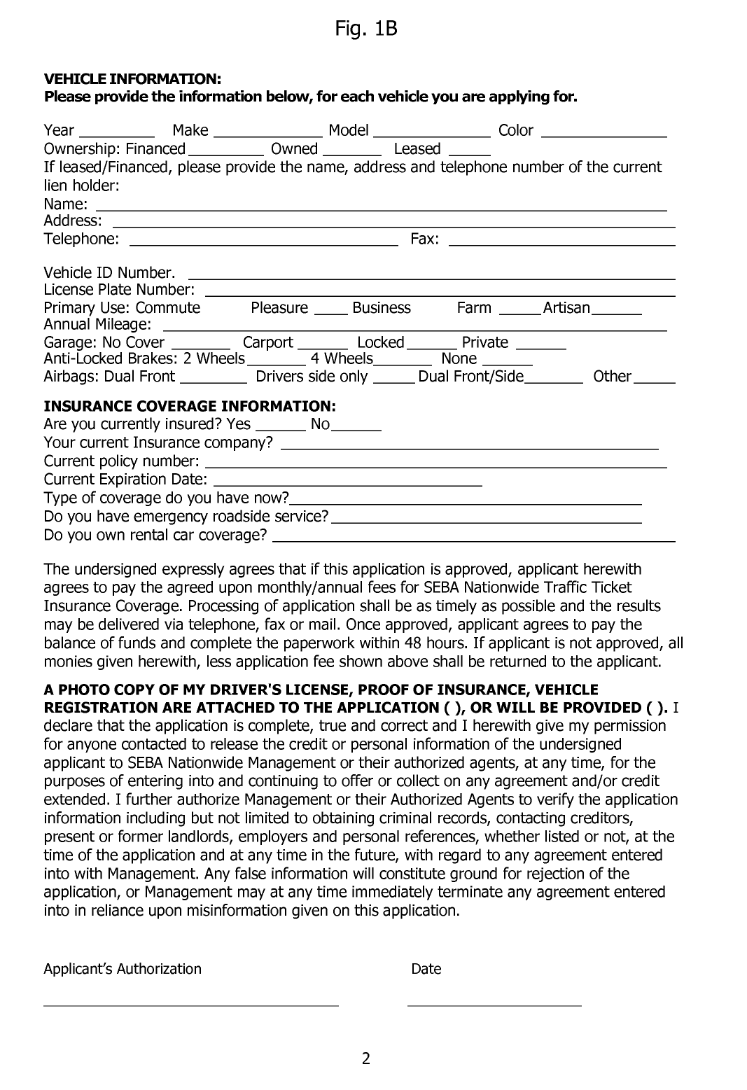

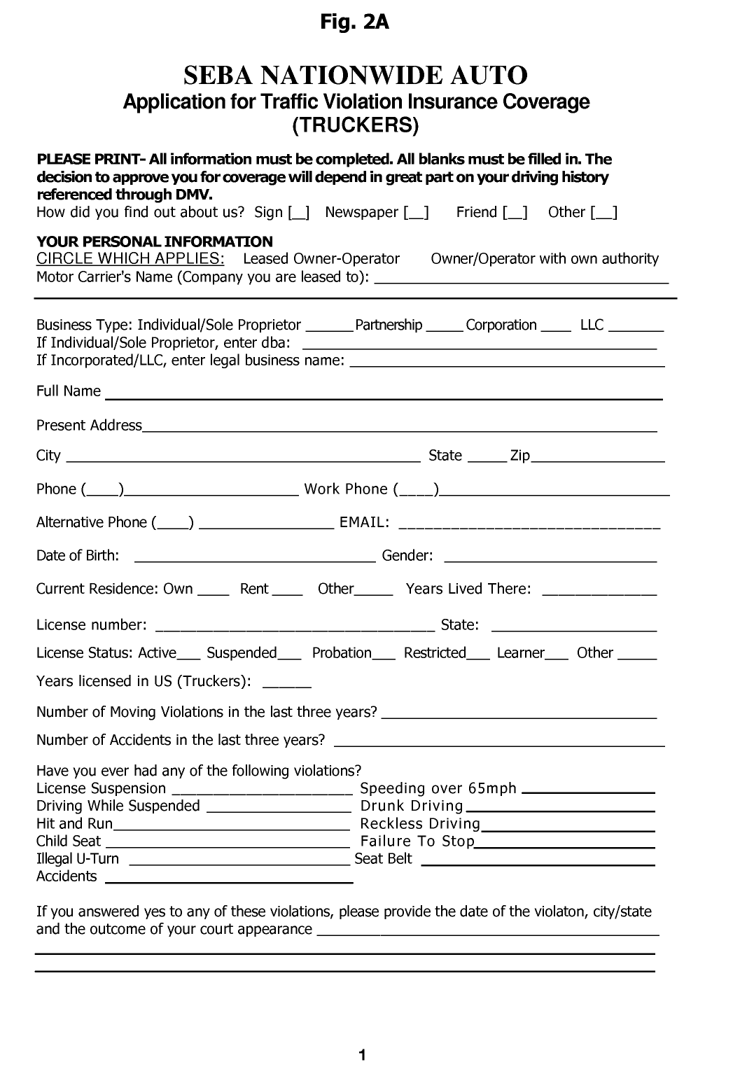

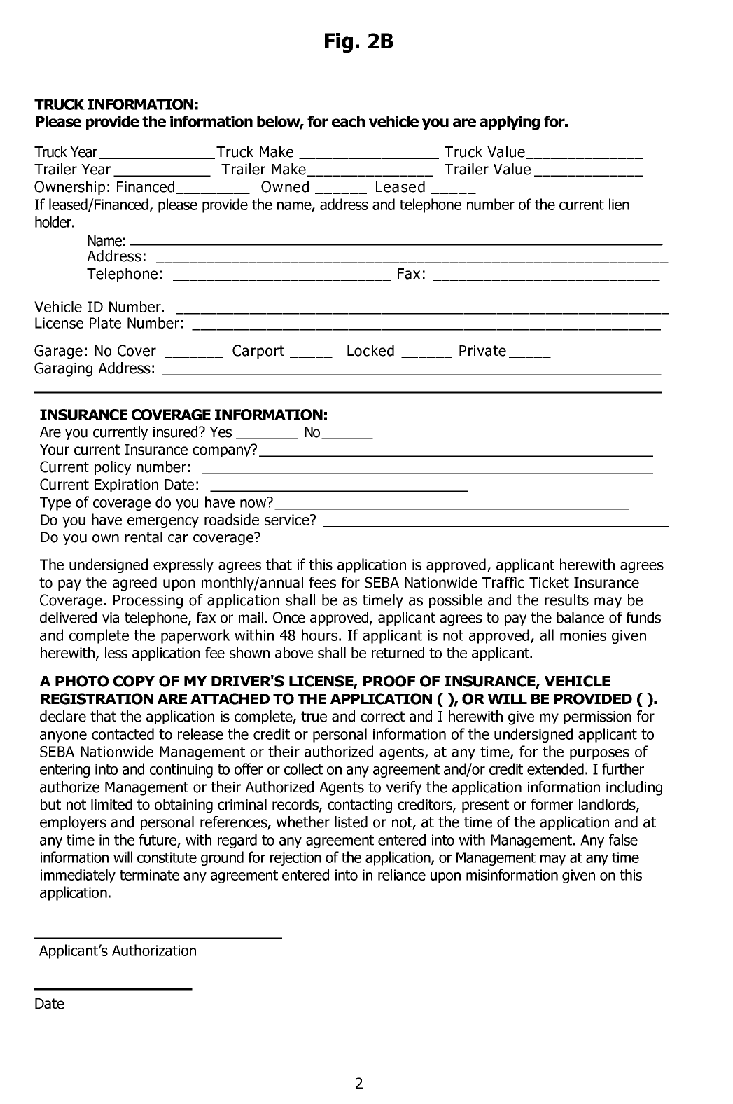

Referring now to FIG. 1 there is shown a first page of an application for auto repairs coverage for a vehicle. Referring to FIG. 2 there is shown a second page of the application for auto repairs coverage. The application as shown in FIGS. 1 and 2 are provided to the vehicle owner and/or operator for completion. The application includes identifying information regarding the applicant, coverage information regarding the applicant and/or vehicle, and information vehicle's identification and condition, including, but not limited to the vehicle's make and model, vehicle identification number (VIN) number, license plate, primary use, approximate annual mileage, and safety features of the vehicle. The owner/operator completes the application and sends the application to an insurance carrier. The insurance carrier reviews and evaluates the received information to determine insurability of the vehicle. If the carrier determines the vehicle can be insured, the carrier performs a vehicle inspection—either by the carrier itself or through an approved inspection provider such as an approved repair shop, mechanic, claims adjuster, or similar inspection provider.

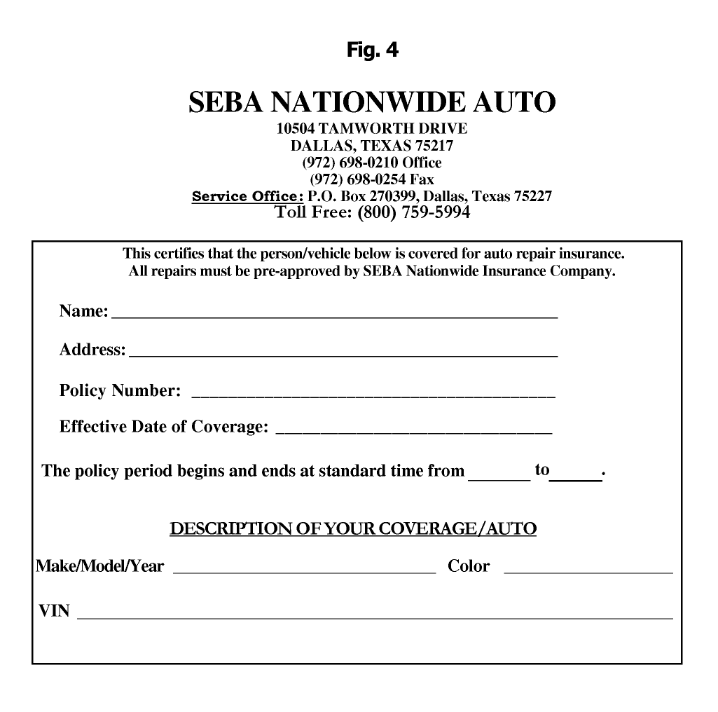

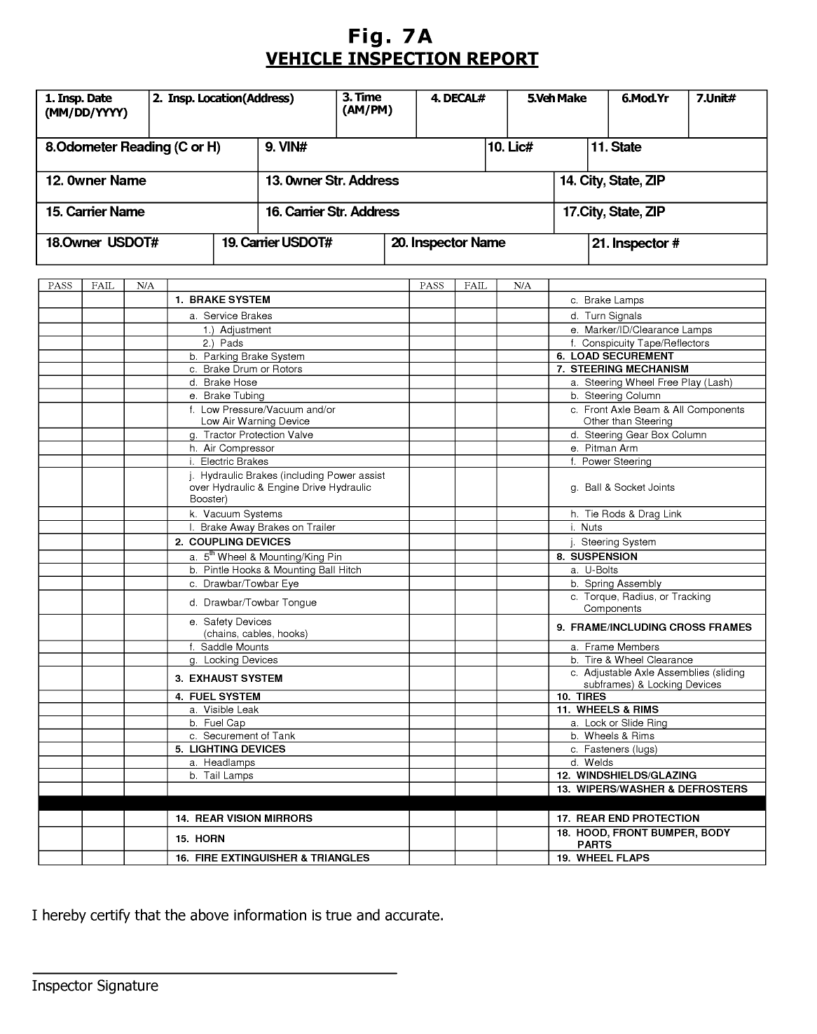

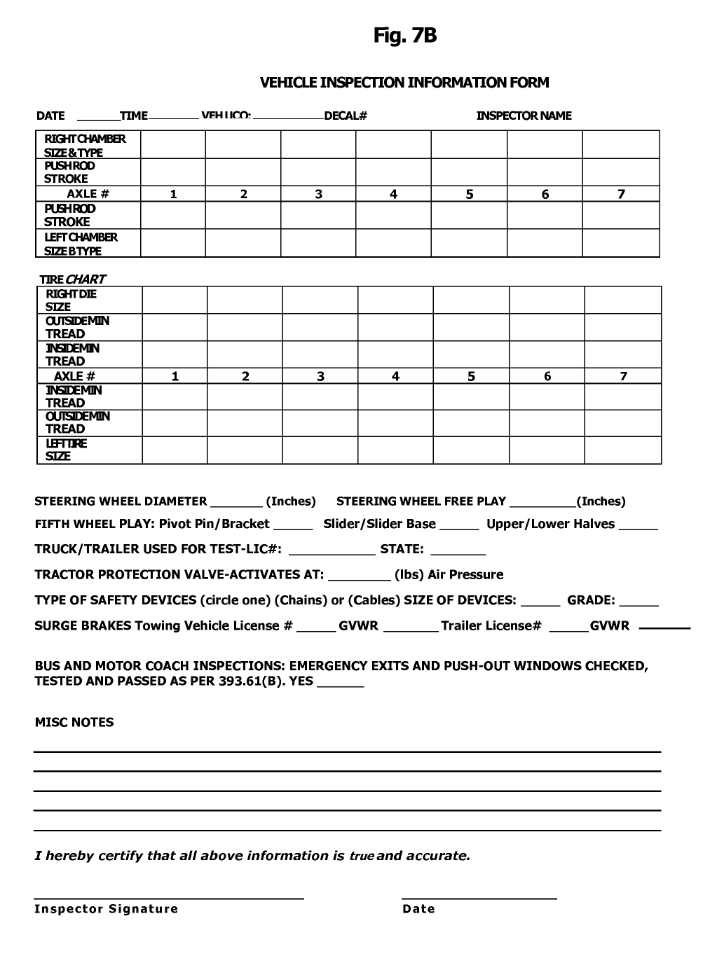

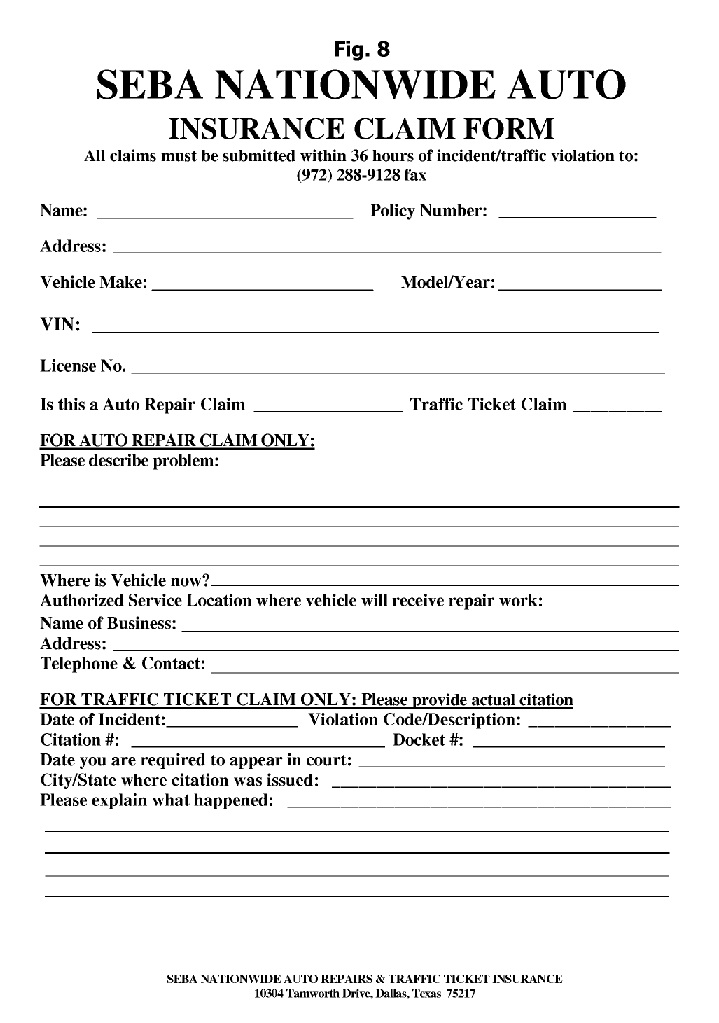

Referring now to FIGS. 7A and 7B there are shown examples of inspection forms which may be used for inspection and evaluation of the vehicle's condition. The inspection reviews the major mechanical and electrical systems of the vehicle and a pass or fail status may be determined for each system and component therein and may also include diagnostic testing on certain systems of the vehicle. The inspection may also include the overall condition of both the interior and exterior of the vehicle. After completion of the inspection and evaluation, the carrier then determines whether certain parts of the vehicle may be excluded from the policy. For example, any pre-existing damage to the exterior or interior of the vehicle will not be covered, so certain features of the vehicle body or interior may be specifically excluded from coverage. Once the inspection is completed, the carrier notifies the vehicle owner/operator of the results and the level of coverage granted for the vehicle. A proof of coverage card such as the card shown in FIG. 4 is then provided to the owner/operator, now a policyholder, along with claim forms to be submitted for future claims. The claim form may comprise a form similar to the example shown in FIG. 8.

Once a coverage policy is approved for the operator of a vehicle, the carrier determines a premium amount payable by the policyholder for the approved coverage. The premium amounts and policy terms are to be determined according to regulations provided by the state's insurance commission for the state in which the vehicle is registered. Policies may be provided in terms of either six months or one year increments.

In the event the owner/operator experiences a breakdown or damage to the vehicle, the policyholder submits a claim form to the carrier. The carrier receives the completed claim form and determines what monetary amount is necessary to repair the vehicle. The carrier may determine the monetary amount by getting one or more mechanic's assessment of the vehicle's condition. The carrier may also utilize an approved listing of repair shops and prices set by each repair shop. Upon determining the amount needed for repairs, the carrier may either pay an approved repair shop directly for the repairs made, or may provide monetary reimbursement to the policyholder for the policyholder to select their own repair shop.

Each policyholder may submit up to two claims per month with a maximum of three claims per year. Any additional repairs required may be reimbursed at a reduced negotiated rate to the policyholder. Further, the vehicle repair insurance will not cover repairs needed as a result of auto accidents nor any pre-existing damage or broken parts of the vehicle.

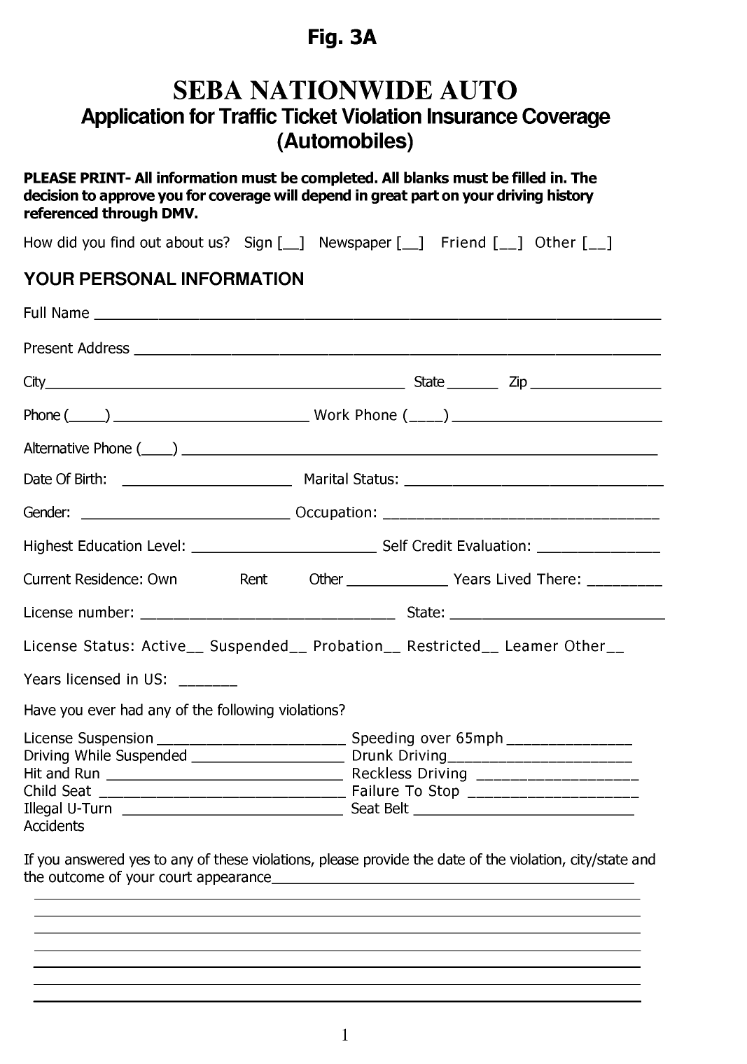

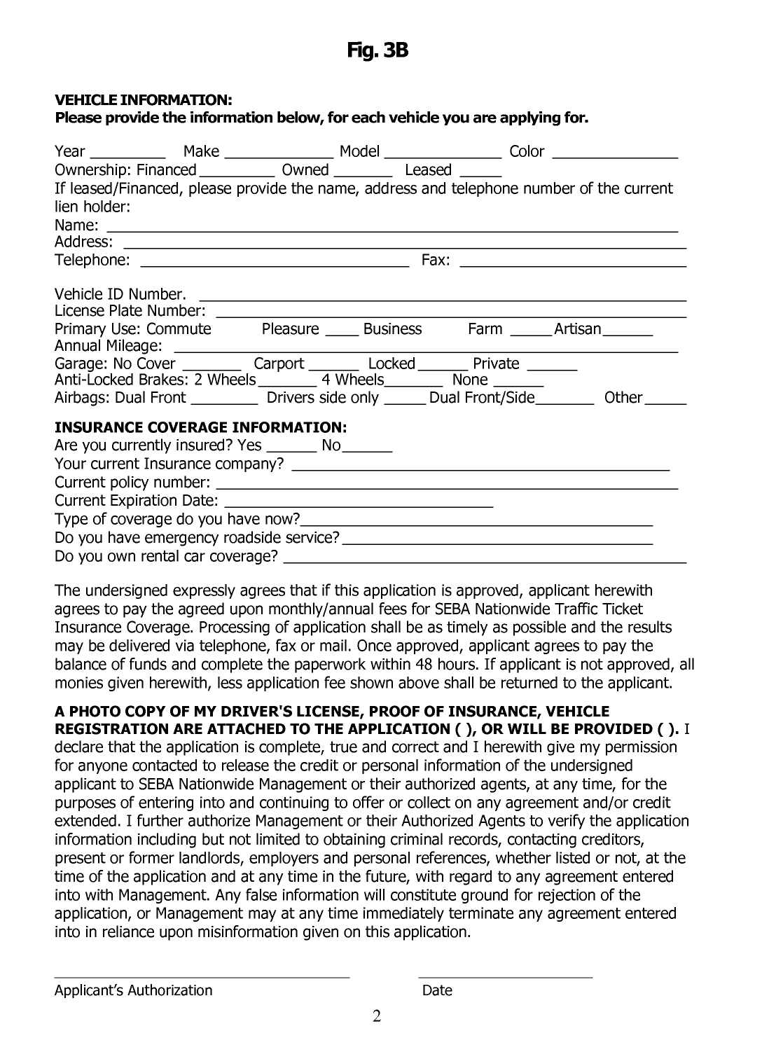

Referring now to FIGS. 2A and 2B and FIGS. 3A and 3B there are shown a first and second page of an application for traffic violation coverage for a commercial truck operator and non-commercial automobile operators, respectively. The applications for both the truck and automobile operator may request identification information for a driver, voluntary driving record information from the driver, vehicle information, other insurance coverage on the vehicle, and other pertinent information regarding the operator and/or vehicle. The application according FIG. 2A may also request commercial licensing information and the type of business either owning or operating the vehicle. The owner/operator completes the application and sends the application to an insurance carrier. The insurance carrier reviews and evaluates the received information to make an initial determination regarding insurability of the operator of the vehicle.

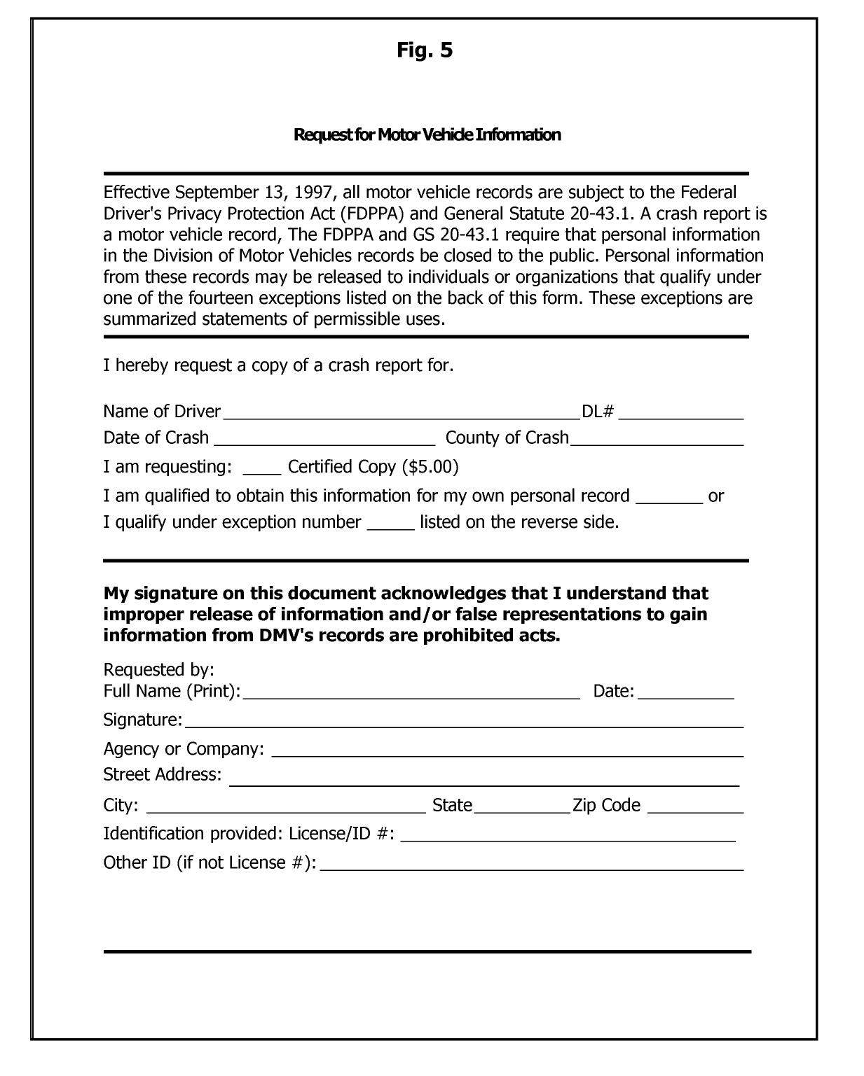

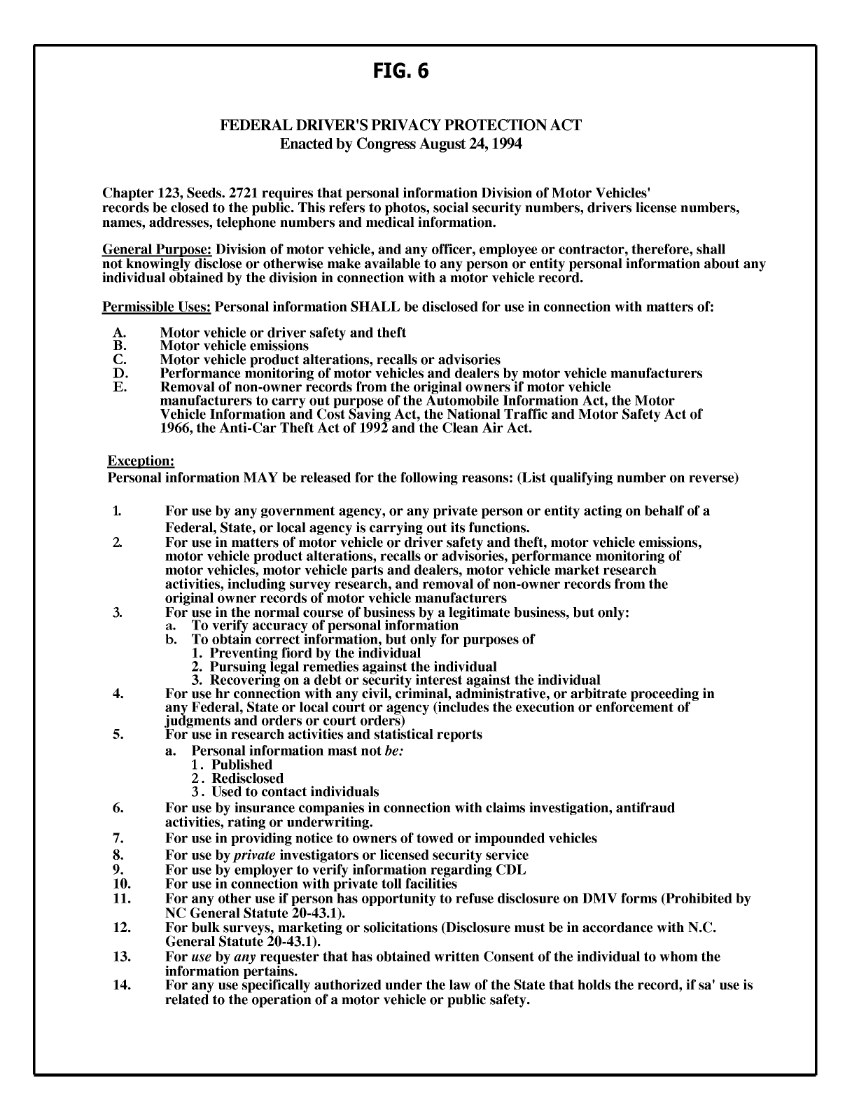

Referring now to FIG. 5 there is shown an example of a request for motor vehicle information which may be sent to a state's department of motor vehicles. An insurance carrier provides the form to an owner/operator seeking insurance coverage for traffic violations in conjunction with the application for insurance according to FIGS. 2A through 3B. FIG. 6 shows a sample information sheet regarding the Federal Driver's Privacy Protection Act which may be provided in conjunction with the application shown in FIG. 5. Upon completion of the application according to FIG. 5, the owner/operator returns the completed form to the insurance carrier who thereafter requests the driver information from at least one state's department of motor vehicles. Accordingly, for a commercially operated truck or for vehicles routinely operated across state lines wherein an operator may be licensed in more than one state, the insurance carrier may want to review driving records for all states in which the operator of the vehicle is licensed.

Once the carrier has received the completed application and driver records, the carrier must make a determination regarding insurability of the operator. There may be some instances where coverage is not granted. Fir example, a driver having excessive driving under the influence (DUI) charges may not receive coverage, likewise any driver having multiple citations or repeat offenses on their driving record may also be denied coverage. If an operator is determined to be insurable, a proof of coverage card such as the card shown in FIG. 4 is then provided to the owner/operator along with claim forms to be submitted for future claims. The claim form may comprise a form similar to the example shown in FIG. 8.

Once a coverage policy is approved for the operator of a vehicle, the carrier determines a premium amount payable by the owner/operator, now a policyholder, for the approved coverage. The premium amounts and policy terms are to be determined according to regulations provided by the state's insurance commission for the state in which the vehicle is registered. Policies may be provided in terms of either six months or one year increments.

In the event the policyholder receives a traffic citation, the policyholder submits a claim form similar to the example shown in FIG. 8 to the carrier within 10 days of receiving the citation. Any citation reported not reported within 15 days of issuance will not be covered by the insurance policy. The carrier receives the completed claim form and determines whether the traffic citation received by the policyholder is a covered offense. If covered, the insurance carrier handles any payment or appearances required to resolve the traffic citation and thereafter notifies the policyholder that the citation has been resolved.

Each policyholder may submit up to two claims per month with a maximum of three claims per year. Only approved operators listed and approved for each policy will be covered by the insurance policy. Certain occurrences may result in immediate denial and cancellation of coverage, including but not limited to two or more DUI violations, three or more driving without a license citations, and any other conditions which may be agreed upon prior to issuance of the insurance policy.

Accordingly, the process for processing the insurance applications according to FIGS. 1A through 3B and described hereinabove may be handled through a computer system and incorporates into a computer software program. For example, a computer software program utilized for repair claims may access a database of approved repair shops and approved prices and thereafter refer the policyholder to one or more shops selected from the database. Likewise, the database may comprise a listing of approved driver safety courses including associated costs and benefits whereby a carrier may provide the policyholder with a listing of course providers selected from the database, thereby eliminating the need for the policyholder to research and select a driver safety course that meets their need for ticket dismissal, as applicable. Further, the insurance coverage for both repairs and ticket citation coverage may be provided by an online system whereby a policyholder can access and complete the required forms.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

We claim:

1. A method for providing insurance for resolving traffic violations comprising:
providing a coverage request application to a vehicle operator;
providing a request for driving records to the vehicle operator;
receiving a completed coverage request application from the vehicle operator;
requesting the vehicle operator's driving record from at least one state;
receiving the driving record from at least one state;
evaluating the received driving record and determining whether to provide traffic violation insurance to the operator; and
providing a completed proof of coverage card to the vehicle operator.

2. The method for providing insurance according to claim 1 further comprising receiving regular premium payments from the vehicle operator.

3. The method for providing insurance according to claim 1 further comprising:
receiving a completed claim form from the vehicle operator having a requested reimbursement amount for a received traffic violation;
processing the received claim;
approving the claim; and
resolving the traffic violation for the vehicle operator.

4. The method according to claim 3 further comprising accessing a database comprising a listing of approved driver safety courses and associated features for each course and thereafter providing a list of approved courses selected from the database to the vehicle operator.

5. The method for providing insurance according to claim 1 wherein the vehicle operator owns the vehicle.

6. The method for providing insurance according to claim 1 wherein the vehicle operator is a truck driver operating a commercially licensed truck.

7. A method for providing insurance for vehicle repairs comprising:
providing a coverage request application to a vehicle operator;
receiving a completed coverage request application from the vehicle operator;
performing an inspection of the vehicle and preparing a report of the vehicle's condition;
evaluating the prepared report and determining a coverage level for the vehicle; and
providing a completed proof of coverage card to the vehicle operator.

8. The method for providing insurance according to claim 7 further comprising receiving regular premium payments from the vehicle operator.

9. The method for providing insurance according to claim 7 further comprising:
receiving a completed claim form from the vehicle operator having a requested repair needed for the automobile;
processing the received claim;
determining a monetary amount necessary to repair the vehicle;
approving the claim; and
disbursing the determined monetary amount to the vehicle operator.

10. The method for providing insurance according to claim 9 further comprising providing the vehicle operator with a report detailing approved repair shops and each shop's provided prices to complete the repairs to the vehicle.

11. The method for providing insurance according to claim 7 wherein the vehicle operator owns the vehicle.

12. The method for providing insurance according to claim 7 wherein the vehicle operator is a truck driver operating a commercially licensed truck.
